(19) United States
(12) Patent Application Publication
(10) Pub. No.: US 2026/0205208 A1
(43) Pub. Date: Jul. 16, 2026

(54) ANTENNA CALIBRATION

(71) Applicant: Swift Beat, LLC, Menlo Park, CA (US)

(72) Inventors: Reese FRERICHS, Boston, MA (US); Alexander MEZHIROV, Lexington, MA (US)

(21) Appl. No.: 19/446,777

(22) Filed: Jan. 12, 2026

Related U.S. Application Data
(60) Provisional application No. 63/744,144, filed on Jan. 10, 2025.

(51) Int. Cl. H04B 17/12; H04B 1/69; H04B 7/0404; H04B 17/14; H04B 17/20

(52) U.S. Cl. CPC H04B 17/12; H04B 1/69; H04B 7/0404; H04B 17/14; H04B 17/25; H04B 2001/6912

(57) ABSTRACT

An antenna calibration system and method use a transmitter antenna array and a receiver antenna array. Calibration automatically initiates in response to a trigger condition. Each receiver antenna in the receiver antenna array receives frequency-modulated signals from the transmitter antenna array. Optionally, the transmitter antenna array transmits signals of increasing frequency (“up chirps”) and/or signals of decreasing frequency (“down chirps”). The frequency-modulated signals are processed through matched filters to determine filter responses. The phase differences for each receiver antenna are calculated based on the filter responses. Calibration coefficients for each receiver antenna are generated based on the calculated phase differences. The phase of signals received from the receiver antennae are then adjusted using the respective calibration coefficients.

### CROSS REFERENCE TO RELATED APPLICATION

This application claims the benefit of U.S. Provisional Patent Application Ser. No. 63/744,144 filed on Jan. 10, 2025, and entitled “Antenna Calibration”, which is hereby incorporated by reference in its entirety for all intents and purposes.

### BACKGROUND

Antennas receive and transmit wireless electromagnetic signals. To make sense of received signals, the antenna system processes the waveforms of the received signal into an interpretable form, often using an analog-to-digital converter. For an antenna system to function properly, the components that interpret the received signals must be designed for the properties of the connected antenna. To resolve errors, some antenna systems need to be calibrated prior to use. In addition, if an antenna array is used in a hazardous environment, then the array can require recalibration on a regular basis to prevent performance disruptions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some examples provide an antenna calibration system comprising: a receiver antenna array; a transmitter antenna array; a processor; and a memory comprising computer program code. The memory and the computer program code are configured to cause the processor to: automatically initiate calibration in response to a trigger condition; receive frequency-modulated signals from the transmitter antenna array at each receiver antenna; process the frequency-modulated signals through matched filters to determine filter responses; calculate phase differences for each receiver antenna; generate calibration coefficients based on the phase differences; and adjust the phase of signals received using the calibration coefficients.

Other examples provide a method for calibrating two receiver antennae using two transmitter antennae comprising: automatically initiating calibration in response to a trigger condition; receiving frequency-modulated signals at each receiver antenna; processing the frequency-modulated signals through matched filters to determine filter responses; calculating phase differences for each receiver antenna; generating calibration coefficients based on the phase differences; and adjusting the phase of signals received using the calibration coefficients.

Further examples provide a non-transitory computer storage medium having computer-executable instructions that, upon execution by a processor, cause the processor to at least: automatically initiate calibration in response to a trigger condition, wherein calibration involves two or more receiver antennas; receive frequency-modulated signals at each receiver antenna, wherein the frequency-modulated signals are transmitted from two or more transmitter antennas; process the frequency-modulated signals through matched filters to determine filter responses; calculate phase differences for each receiver antenna; generate calibration coefficients based on the phase differences; and adjust the phase of signals received using the calibration coefficients.

### BRIEF DESCRIPTION OF THE DRAWINGS

The present description will be better understood from the following detailed description read considering the accompanying drawings, wherein:

FIG. 1 is a block diagram illustrating an example system for calibrating receiver antennae;

FIG. 2 is a block diagram illustrating an example system for calibrating receiver antennae with two transmitter antennae and four receiver antennae;

FIGS. 3A-C are charts illustrating the short-time Fourier transform of signals in an example scenario;

FIG. 4 is a polar plot illustrating the matched filter responses of received signals in an example scenario;

FIG. 5 is a flow chart illustrating an example process of calibrating receiver antennae;

FIG. 6 is a flow chart illustrating another example process of calibrating receiver antennae;

FIGS. 7A-D are illustrations of example implementations of antennae calibration systems; and

FIG. 8 illustrates an example computing apparatus as a functional block diagram.

Corresponding reference characters indicate corresponding parts throughout the drawings. The drawings may not be to scale. Any of the figures may be combined into a single example or embodiment.

### DETAILED DESCRIPTION

An antenna array is an array of transmitting and/or receiving antennas. Receiving antennas receive signals for processing by other components. The electrical path length of all receiver antennas in an antenna array must be known to accurately process the signals received from each antenna. This occurs during calibration. However, when an antenna array encounters vibrations, shocks, or temperature changes, the electrical paths from the antennas to signal-processing components can deviate, and result in inaccurate processing. For example, this causes array radiation pattern distortion that degrades overall performance. Hence, to maintain an acceptable level of performance of an antenna array, re-calibration may be necessary over time. Traditional re-calibrations are a manual and time-consuming process, often requiring direct intervention or asymmetrical equipment configurations to adjust for path length variation.

For example, some prior calibration methods rely on the manual use of external calibration hardware, such as an Active Radar Calibrator (ARC), to ensure that the phases of incoming signals are aligned across the receiver antennas. These systems cannot automatically initiate array calibration on-the-fly because the calibration equipment is not integrated into the array application. The manual use of standalone calibration equipment increases complexity and costs, and ultimately limits the performance of different antenna array use cases where calibrated antennas are necessary. That is, the use of standalone calibration equipment is simply not feasible in certain antenna use case scenarios. For example, manual calibration is not suited for antenna array applications in hazardous environments (e.g., poor weather, the vacuum of outer space), because of the increased risk and costs involved. This also extends to implementations where the antennas must be calibrated frequently, as it is not practicable to continuously calibrate an array using manual methods at least because of the repeated costs.

In contrast, aspects of the disclosure include an improved system and method for automatic, adaptive, and dynamic calibration of antenna arrays, capable of operating across a broad spectrum of environmental conditions without necessitating manual intervention or extensive hardware adjustments. An example calibration process involves estimating the relative delay for signals sent to receiver antennas caused by electrical path length differences in electronics. Frequency-modulated signals, such as Linear Frequency modulations (“LFMs”) or Compressed High-Resolution Pulses (“chirps”), are transmitted from two or more transmitter (“Tx”) antennas (a “transmitter array”) to two or more receiver (“Rx”) antennas (a “receiver array”). For the purposes of this specification, the term “chirps” includes other frequency-modulated signals and schemes unless specifically referring to a signal with increasing or decreasing frequencies. The received chirps are passed through parallel matched filters to estimate the electrical path length for each receiver antenna. From the estimated electrical path length, calibration coefficients are generated for each receiver antenna that modify incoming signals so that the phase of all received signals is matched. In some examples, there are four or more antennas: two or more transmitter antennas and two or more receiver antennas.

The calibration coefficients are derived from the matched filter responses to the received chirp waveforms over time. When the received signal is a chirp, the frequency is either increasing or decreasing. The simultaneous transmission of both types of chirps allows for simultaneous decoding by passing each chirp through its own parallel matched filter. The responses from the parallel matched filters can be used to accurately estimate the electrical path length between two receiver antennas. The calibration coefficients can be derived from the phase differences resulting from the electrical path length differences between receiver antennas. Other methods for deriving the calibration coefficients are contemplated.

Unlike prior manual systems that were unable to adequately adapt to real-time changes and environmental variations such as vibration, shock, and temperature fluctuations, the disclosed systems and methods dynamically generate calibration coefficients for each receiver antenna, facilitating precise signal phase alignment across the receiver antenna array. Each incoming signal from a receiver antenna is multiplied by its respective coefficient to align the phase of the signal, and this is performed for each of the receiver antennas in the array.

Aspects of the disclosure are operable in a wide range of applications where the electrical path lengths of the receiver antennas shift over time-such as from repeated vibrations, shocks, temperature changes, and/or other factors. Some examples of applications with repeated vibrations include: an antenna array subject to high wind speeds, an antenna array fixed to a vehicle with an internal combustion engine, such as an off-road vehicle, and an antenna array on a multistage rocket. Additionally, some examples of applications with repeated shocks include: an antenna array inside a package designed to measure shocks during mailing and delivery, an antenna array embedded within a cellular phone, an antenna array embedded in a football helmet, an antenna array embedded within a sports ball, and an antenna array in a vehicle designed to withstand powerful projectile impacts. Further, some examples of applications with repeated temperature changes include: an antenna array in an extreme-temperature environment, an antenna array on a remotely-operated vehicle designed to fight fires, and an antenna array on a satellite or other extraterrestrial device/system.

An example technical effect of the disclosed technology is the enhancement of calibration accuracy and operational reliability of antenna array systems. This is achieved through the automatic and adaptive calibration of receiver antennas using, for example, chirps and matched filter processing. The technology addresses variations in electrical path lengths due to environmental factors such as vibration, shock, and temperature changes. By generating calibration coefficients based on the phase differences of received chirp waveforms, the method ensures precise phase alignment of signals across receiver antennas. This adaptive calibration capability minimizes manual intervention, reduces computational resources used, and supports consistent performance across diverse environments, improving the system's overall reliability and scalability and performance of underlying computing devices.

An example antenna calibration system comprises: a receiver antenna array, a transmitter antenna array, a processor, and memory comprising computer program code. The memory and the computer program code are configured to cause the processor to automatically initiate calibration in response to a trigger condition, receive chirps from the transmitter antenna array at each receiver antenna, process the chirps through matched filters to determine filter responses, calculate phase differences for each receiver antenna, generate calibration coefficients based on the phase differences, and adjust the phase of signals received using the calibration coefficients.

Other examples provide a method for calibrating a receiver antenna array using a transmitter antenna array comprising: automatically initiating calibration in response to a trigger condition; receiving chirps at each receiver antenna; processing the chirps through matched filters to determine filter responses; calculating phase differences for each receiver antenna; generating calibration coefficients based on the phase differences; and adjusting the phase of signals received using the calibration coefficients.

Further examples provide a non-transitory computer storage medium having computer-executable instructions that, upon execution by a processor, cause the processor to at least: automatically initiate calibration in response to a trigger condition, wherein calibration involves two or more receiver antennas; receive chirps at each receiver antenna, wherein the chirps are transmitted from two or more transmitter antennas; process the chirps through matched filters to determine filter responses; calculate phase differences for each receiver antenna; generate calibration coefficients based on the phase differences; and adjust the phase of signals received using the calibration coefficients.

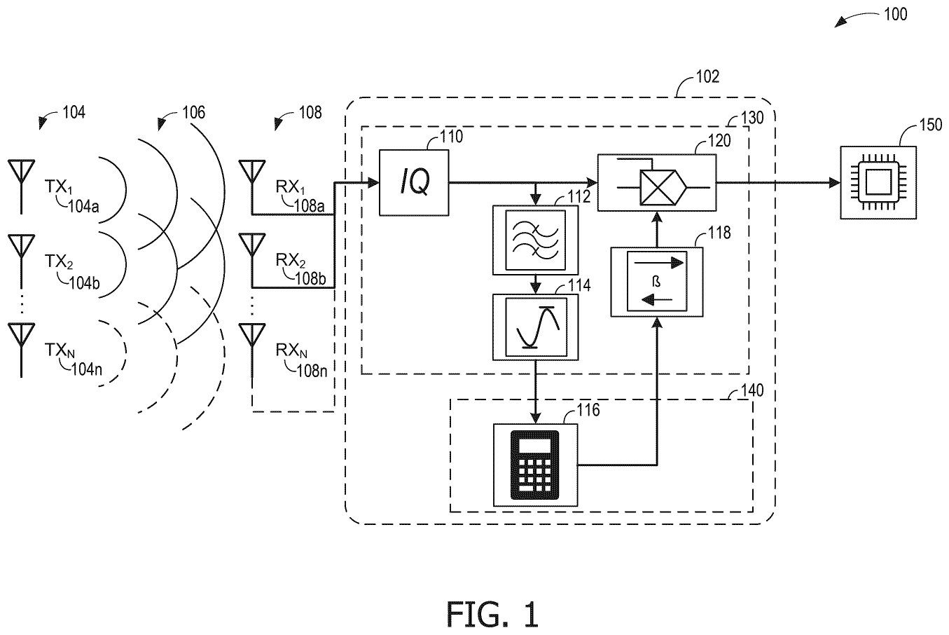

Referring next to the figures, FIG. 1 illustrates an example system 100 for calibrating an antenna array. Two or more transmitter antennas 104a-n (collectively 104) send chirps 106 to two or more receiver antennas 108a-n (collectively 108). The receiver antennas 108 send the received signals to a calibration environment 102. The calibration environment 102 comprises an in-phase and quadrature (IQ) recorder 110, a parallel matched filter 112, a peak detector 114, a phase calculator 116, calibration weights 118, and a multiplier 120. The components of the calibration environment 102 calibrate the received signals and send them to a digital signal processor (DSP) 150 for signal processing. Components of system 100 can correspond to other components of the disclosure.

The calibration process begins with the transmission of chirps 106, from two or more transmitter antennas 104. In some versions, these chirps 106 encompass at least one signal with an increasing frequency trajectory (an “up chirp”) and another with a decreasing frequency trajectory (a “down chirp”). Each chirp 106 is transmitted through the medium to two or more receiver antennas 108 arranged within an antenna array. In some implementations, a transmitter antenna 104 can transmit multiple chirp waveforms to the receiver antennas 108. The ratio of transmitter antennas to receiver antennas does not impact calibration effectiveness, in some examples.

The chirps can be processed in parallel or sequentially. In at least one embodiment, the processing is performed sequentially. Sending the chirps at different times allows for simpler processing, which reduces the computational hardware required to process the chirps. In contrast, processing the chirps in parallel reduces overall processing time. The chirps can have any duration, wavelengths, and frequencies. A single transmitter is capable of calibrating the receiver antennas, but it results in significantly higher errors. In some versions, the entire calibration process occurs between 2-30 milliseconds. In at least one version, the entire calibration process occurs between 5-15 milliseconds.

When the received signals from the receiver antennas 108 enter the calibration environment 102, the IQ recorder 110 records the in-phase and quadrature components (“IQ data”) equal to the length of the signals. The IQ data represents both the real and imaginary values of the signals. Since the quadrature components (“Q-data”) are the in-phase components (“I-Data”) rotated by 90°, the imaginary values of the signal can be digitized.

Each received signal is passed through two or more parallel matched filters 112. The resulting filtered signals are known as “matched filter responses.” Each matched filter 112 is specifically tailored to correspond to the frequency modulation characteristics of the transmitted chirp waveforms 106. In other words, there is one parallel matched filter 112 per chirp waveform 106 from a transmitter antenna 104. A matched filter is the optimal linear filter for maximizing the Signal-to-Noise Ratio (SNR) for a known signal in the presence of additive stochastic noise. A peak detector 114 then detects the peak of the matched filter responses for each chirp waveform 106.

The resulting complex values are passed to a phase calculator 116 to compute calibration coefficients (i.e. weights) 118 to calibrate future signals. The phase calculator 116 computes the phase differences observed in the peak responses for each receiver antenna 108. These phase differences are indicative of the variations in electrical path lengths that exist for each receiver antenna 108. In some versions, the calculation is performed by comparing the phase of the matched filter responses for each receiver antenna to an expected phase based on the propagation length. In at least one version, calculating an expected phase of a signal 106 sent from a transmitter antenna 104a to a receiver antenna 108a involves calculating the distance between the transmitter antenna 104a and the receiver antenna 108a in space. The phase calculator 116 then computes the difference between the expected phase and the received phase of a signal 106 to generate calibration coefficients for that receiver antenna 108a.

In some versions, the calibration environment 102 also estimates the physical position of each receiver antenna 108 in space as part of estimating the electrical path length. Depending on the implementation, a default position of the receiver antennas 108 in space is known. As the receiver antennas 108 are subject to repeated shocks, vibrations, or temperature changes, the physical position of the antennas also change. The calibration environment 102 is configured to use the calculated phase differences for each antenna to estimate the physical position of each receiver antenna in space. Additionally, the calibration environment 102 is also configured to estimate the physical position of each transmitter antenna as well. Estimating the physical position of antennas over time increases the accuracy of future calibrations at least because the new estimated position can be used as the default position for the next calibration. Additionally, estimating and recording the physical position of the antennas in space provides valuable data on how particular antennas shift over time in a particular application.

Based on the calculated phase differences, the phase calculator 116 generates calibration coefficients for the receiver antennas 108. The calibration coefficients are representative of the delay introduced by the electrical path length of each receiver antenna and are specific to that antenna. In some versions, the calibration coefficient is a complex value. In at least one example, the coefficient is derived from the response to a matched filter generated from the known transmit signal. Once generated, the calibration coefficients are stored in a calibration weights storage 118.

A multiplier 120 multiplies the calibration coefficients stored in the calibration weights storage 118 with the IQ data on the next received signals. This adjustment involves multiplying the IQ data of each incoming signal by its respective calibration coefficient. In at least one version, multiplying the IQ data with calibration coefficients delays the first-received signals until the phase of all received signals is aligned. The multiplication compensates for phase disparities caused by electrical path differences, thereby ensuring phase alignment across the antenna array. The resulting calibrated signals are then sent to DSP 150 for signal processing.

Finally, the adjustment process is controlled automatically by the system through pre-defined trigger conditions, in some examples. These conditions include system modifications such as wiring changes or component additions, the detection of unexpected signaling conditions, or adherence to a predetermined calibration schedule. Calibration can also be triggered by context-specific factors like geolocation changes or initiating signal capture, ensuring continuous and adaptive performance without manual intervention.

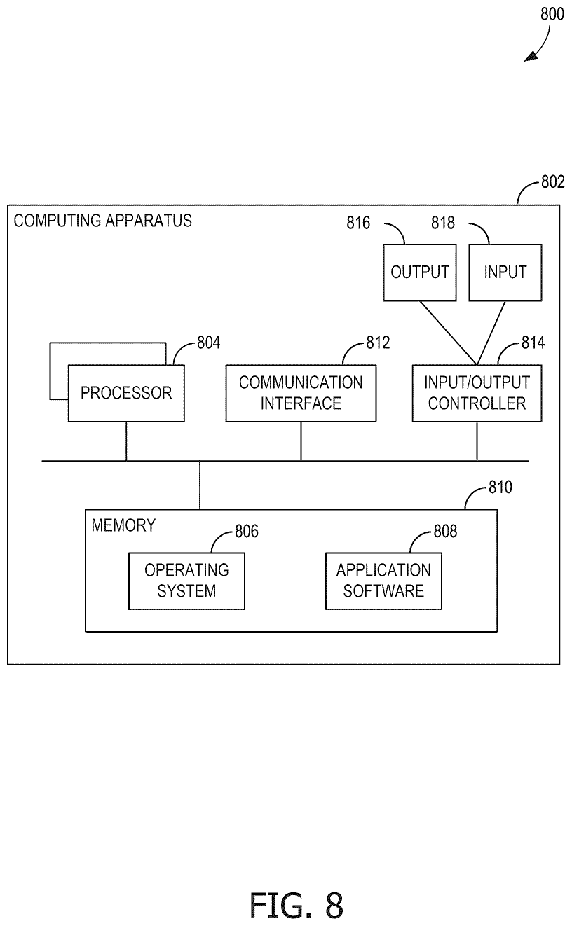

Further, in some examples, the system 100 includes one or more computing devices (e.g., the computing apparatus of FIG. 8) that are configured to communicate with each other via circuitry or one or more communication networks (e.g., an intranet, the Internet, a cellular network, other wireless network, other wired network, or the like). In some examples, entities of the system 100 are configured to be distributed between the multiple computing devices and to communicate with each other via circuitry or network connections. For example, the parallel matched filter 112 is executed on a first computing device 130 and the phase calculator 116 is located on a second computing device 140 within the calibration environment 102. The first computing device 130 and second computing device 140 are configured to communicate with each other via circuitry or network connections. Alternatively, in some examples, other components of the system 100 (e.g., transmitter antennas 104) are executed on separate computing devices and those separate computing devices are configured to communicate with each other via network connections during the operation of the calibration environment 102. In other examples, other organizations of computing devices are used to implement system 100 without departing from the description.

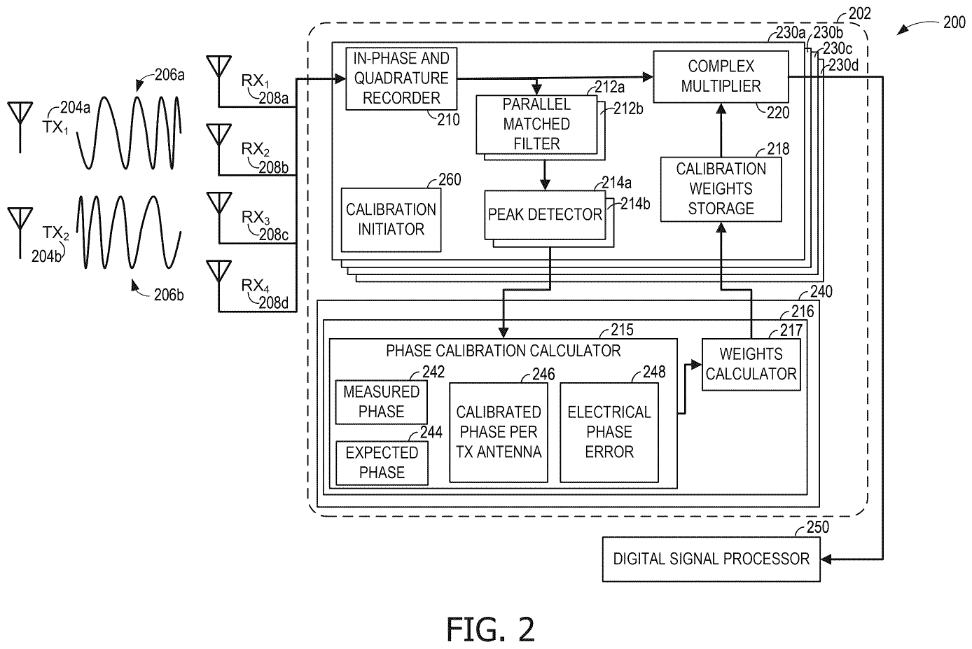

FIG. 2 is a block diagram illustrating an example system 200 for calibrating receiver antennas. Example system 200 uses two transmitter antennas 204a-b (collectively 204) that send chirps 206a-b (collectively 206) to four receiver antennas 208a-d. The receiver antennas 208a-d send the received signals to a calibration environment 202. The calibration environment 202 comprises an IQ recorder 210, four programmable logic devices 230a-d (collectively 230), a computer processor 240, and a calibration initiator 260. The components of the calibration environment 202 calibrate the received signals and send them to a DSP 250 for signal processing. Components of system 200 can correspond to other components of the disclosure.

In the embodiment shown in FIG. 2, the four programmable logic devices 230a-d correspond to a respective receiver antenna 208a-d. Each programmable logic device comprises parallel matched filters 212a-b, peak detectors 214a-b, a calibration weight storage 218, and a complex multiplier 220. The computer processor 240 comprises a phase calculator 216 comprising a phase calibration calculator 215 and a weights calculator 217. In at least one version, the four programmable logic devices 230a-d are field programmable gate arrays (FPGA) programmable logic chips. In at least one example, the computer processor 240 is a FPGA processor system.

In the embodiment shown in FIG. 2, transmitter antenna 204a sends a chirp 206a with an increasing frequency (up chirp) and transmitter antenna 204b sends a chirp 206b with a decreasing frequency (down chirp). Each receiver antenna 208a-d receives both chirps 206a-b. Opposing chirp directions allow for simultaneous decoding by the receiver antennas 208a-d. In at least one example, the chirps may last 1 millisecond over 10 megahertz (MHz). The receiver antennas 208a-d send the received chirps 206a-b to the IQ recorder 210 to record the IQ data.

In some implementations, the calibration process is controlled automatically by a calibration initiator 260. In some embodiments, calibration occurs automatically at a fixed schedule, such as every ten minutes. In other embodiments, calibration is triggered by context-specific factors, such as the location of the receiver antennas matching a geolocation coordinate, a vehicle comprising the receiver antennas powering on, or the vehicle initiating capture of signals, thereby ensuring continuous and adaptive performance without manual intervention. Additional conditions can include system modifications such as wiring changes or component additions, or the detection of unexpected signaling conditions. In at least one version, the vehicle automatically calibrates the receiver antennas prior to capturing signals with the receiver antennas.

In the embodiment shown in FIG. 2, the parallel matched filters 212a and 212b and peak detectors 214a and 214b are specially configured to the chirps 206a and 206b from transmitter antennas 204a and 204b respectively. To calibrate the receiver antennas 208a-d, the IQ data is passed through the parallel matched filters 212a-b, resulting in matched filter responses for each chirp 206a-b. The peak detectors 214a-b then detect the peaks of the matched filter responses for each chirp 206a-b respectively. The resulting data is then sent to the phase calibration calculator 215 of the phase calculator 216.

In some versions, the phase calibration calculator 215 calculates the true electrical phase error 248 for each receiver antenna 208a-d based on computing a calibrated phase for each transmitter antenna 246. The calibrated phase for each transmitter antenna 246 is computed based on calculating the measured phase 242 of the chirp 204a-b and the expected phase 244 due to the known propagation length. In some examples, the expected phase 244 is subtracted from the measured phase 242 to find the calibrated phase for a transmitter antenna 246. In another example, electrical phase error 248 is the result of taking the mean of peak phases across the two or more transmitter antennas. In at least one example, the difference between the electrical phase error 248 and each peak measures the distance delta between a receiver antenna 208a and the two transmitter antennas 204a-b.

In some versions, a weights calculator 217 takes the electrical phase error 248 of a receiver antenna to determine a calibration coefficient for that receiver antenna. In at least one version, the resulting calibration coefficient is a complex value. The calibration coefficient is stored in a calibration weights storage 218. The IQ data of future received signals from receiver antennas 208a-d is multiplied by its respective calibration coefficient with complex multiplier 220 to align the phases of the signals. The resulting calibrated signals are then sent to the DSP 250 for signal processing.

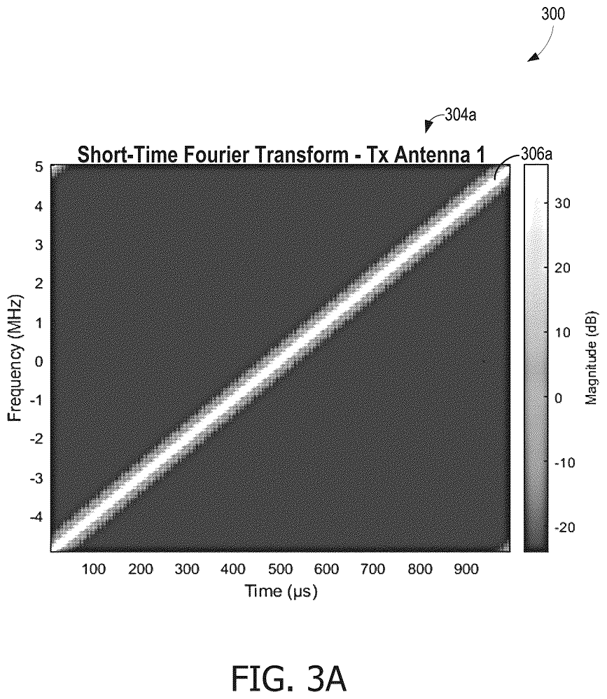

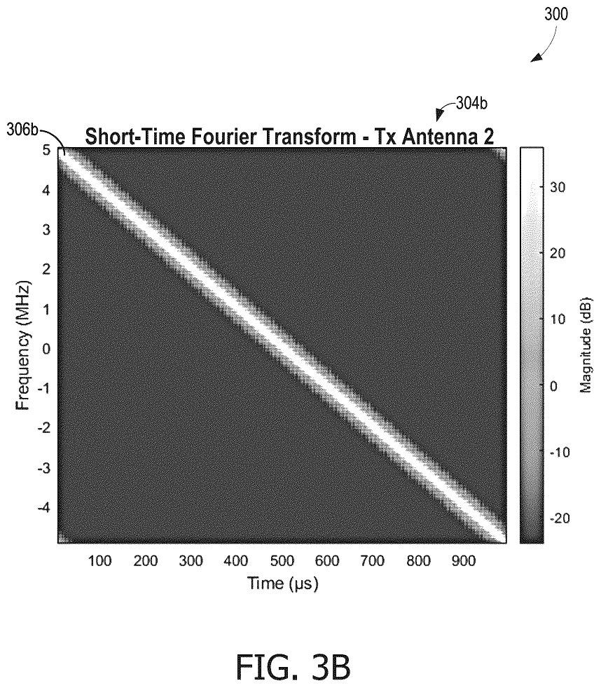

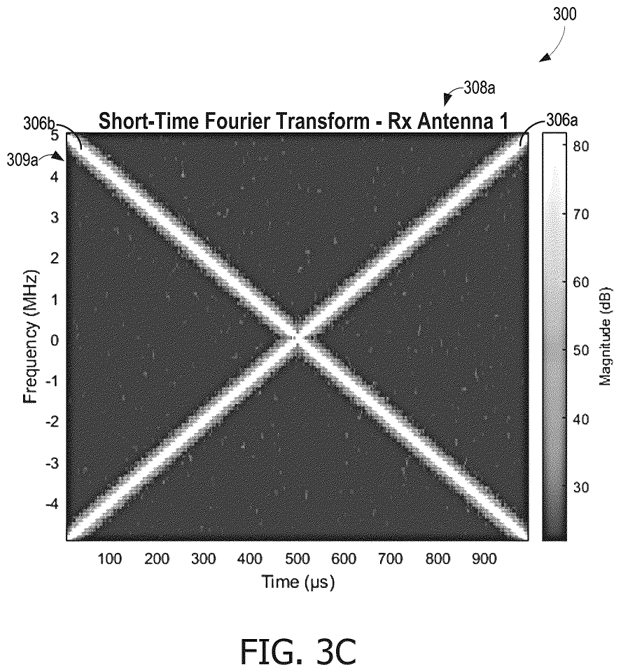

FIGS. 3A-C are charts illustrating the short-time Fourier transform of signals in an example scenario 300. The example scenario 300 involves signals sent from two transmitter antennas that are received by a receiver antenna. In the embodiment shown in FIGS. 3A-3C, the signals are chirps with a duration of 1 millisecond. The short-time Fourier transform is used to determine the sinusoidal frequency and phase content of local sections of a signal as it changes over time. Components of scenario 300 can correspond to other components of the disclosure.

FIG. 3A illustrates the short-time Fourier transform of a chirp 306a sent from a first transmitter antenna 304a, which can correspond to transmitter antenna 204a in FIG. 2. The plotted chirp 306a shows the relative frequency of the chirp over time. 306a is an “up chirp” because it increases 10 MHz in frequency over the duration of the chirp.

FIG. 3B illustrates the short-time Fourier transform of a chirp 306b sent from a second transmitter antenna 304b, which can correspond to transmitter antenna 204b in FIG. 2. 306b is a “down chirp” because it decreases 10 MHz in frequency over the duration of the chirp.

FIG. 3C illustrates the short-time Fourier transform of the combined chirps 309a received at receiver antenna 308a, which can correspond to receiver antenna 208a in FIG. 2. The combined chirps 309a include up chirp 306a and down chirp 306b. In the embodiment shown in FIG. 3C, both chirps 306a and 306b are received simultaneously. Using opposite chirp directions enables simultaneous decoding by the receiver antenna 308a and can be implemented through the use of multiple parallel matched filters and peak detectors as shown in FIG. 2.

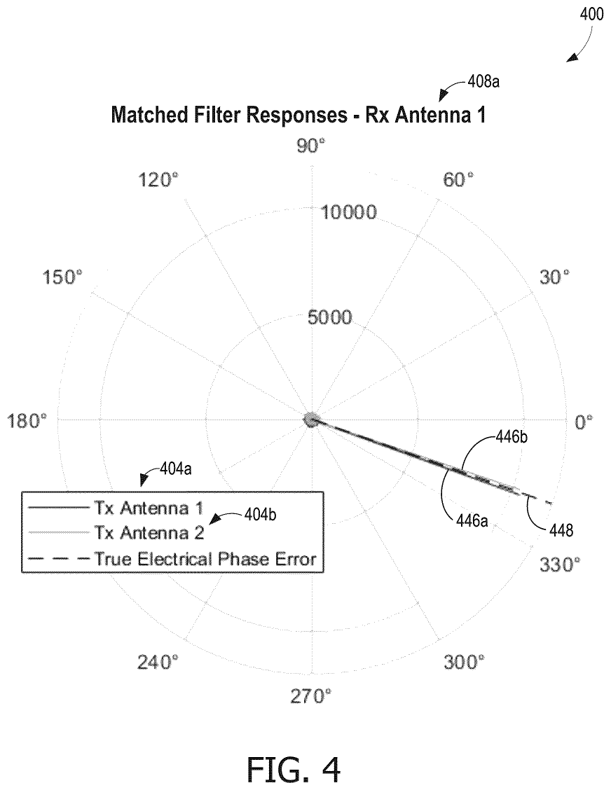

FIG. 4 is a polar plot illustrating the matched filter responses of received signals in an example scenario 400. The example scenario 400 involves signals sent from two transmitter antennas 404a-b that are received by a receiver antenna 408a and passed through parallel matched filters. The matched filter responses represent the bandwidth and peak phases 446a-b of signals received by first receiver antenna 408a from transmitter antennas 404a-b. The angles around the polar plot correspond to phases in degrees and the radial distance represents the bandwidth of the matched filter response. The true electrical phase error 448 of about 340° is also shown for reference. Components of scenario 400 can correspond to other components of the disclosure.

In the embodiment shown in FIG. 4, the peak phase 446a from the first transmitter antenna 404a is about 339° and the peak phase 446b from the second transmitter antenna 404b is about 341°. Both signals from the transmitter antenna 404a-b have a bandwidth of about 10,000 kilohertz (10 MHz). In at least one version, the mean of peak phases 446a and 446b across transmitter antennas 404a and 404b is the true electrical phase error 448.

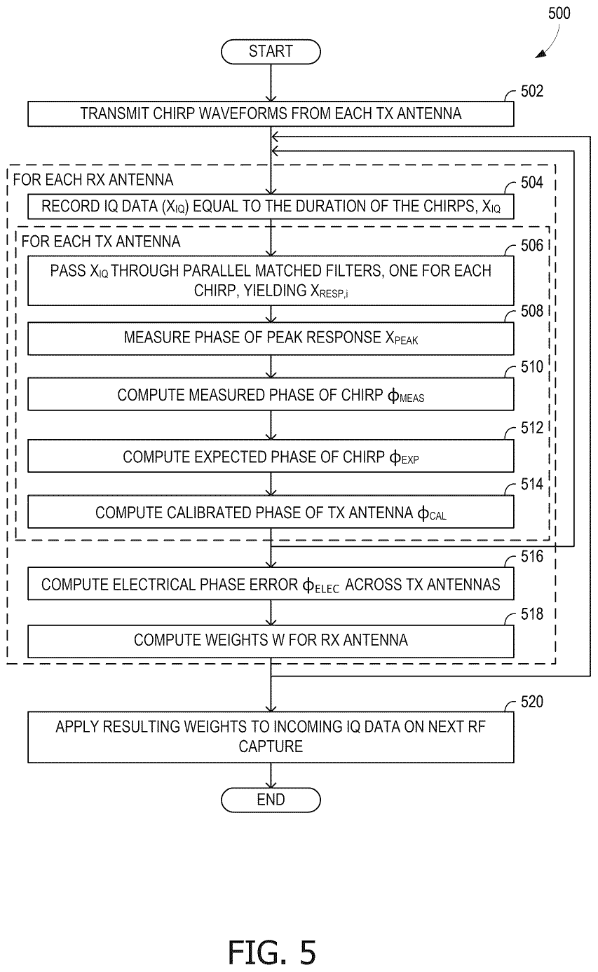

FIG. 5 is a flow chart illustrating an example process 500 of calibrating receiver antennas. Process 500 involves two or more transmitter antennas and two or more receiver antennas. The operations of process 500 can be implemented using the systems and methods of the disclosure, such as systems 100 and 200 in FIGS. 1 and 2.

The process 500 begins with transmitting chirp waveforms from each transmitter antenna at operation 502. Each of the two or more receiver antennas receive the transmitted chirp waveforms from the two or more transmitter antennas. In at least one example, the chirps are in opposing directions (an up chirp and a down chirp).

At operation 504, the IQ data (X_{IQ}) is recorded equal to the duration of the chirps. At operation 506, the IQ data is passed though parallel matched filters, one for each chirp, yielding X_{resp,i}. X_{resp,i} represents the matched filter response for a chirp i from a transmitter antenna i for i=1, 2, . . . n. At operation 508, the phase of the peak response (Xₚₑₐₖ) is measured. In some embodiments, operations 504 through 508 are performed using FPGA programmable logic.

At operation 510, the measured phase of the chirp (Φ_{meas,i}) is computed. At operation 512, the expected phase of the chirp (Φₑₓₚ) is computed. The expected phase is based on the propagation length from the transmitter antenna to the receiver antenna. In some versions, this is computed using vectors Xₜₓ and Xᵣₓ that represent cartesian coordinates in space for the transmitter and receiver antenna respectively. At operation 514, the calibrated phase of the transmitter antenna (Φ_{cal,i}) is computed. Operations 506 to 514 are repeated for each transmitter antenna.

At operation 516, the electrical phase error (Φ_{elec}) is computed across the transmitter antennas. At operation 518, the calibration weights W for each receiver antenna are computed. Operations 504 through 518 are repeated for each receiver antenna. In some embodiments, operations 510 through 518 are performed using a FPGA processor system.

At operation 520, the resulting weights W are applied to incoming IQ data on the next radio frequency (RF) capture. The process 500 ends after operation 520.

The operations of process 500 are performed using the following mathematical algorithms, as an example:

Xₚₑₐₖ=argmax(abs(z_{resp,i}))

Φ_{meas,i}=arctan(imag(zₚₑₐₖ)/real(zₚₑₐₖ))

Φₑₓₚ=2π sqrt(sum((Xₜₓ−Xᵣₓ)²))/λ

Φ_{cal,i}=Φ_{meas,i}−Φₑₓₚ

Φ_{elec}=mean(Φ_{cal,i})

W=exp(−jΦ_{elec})

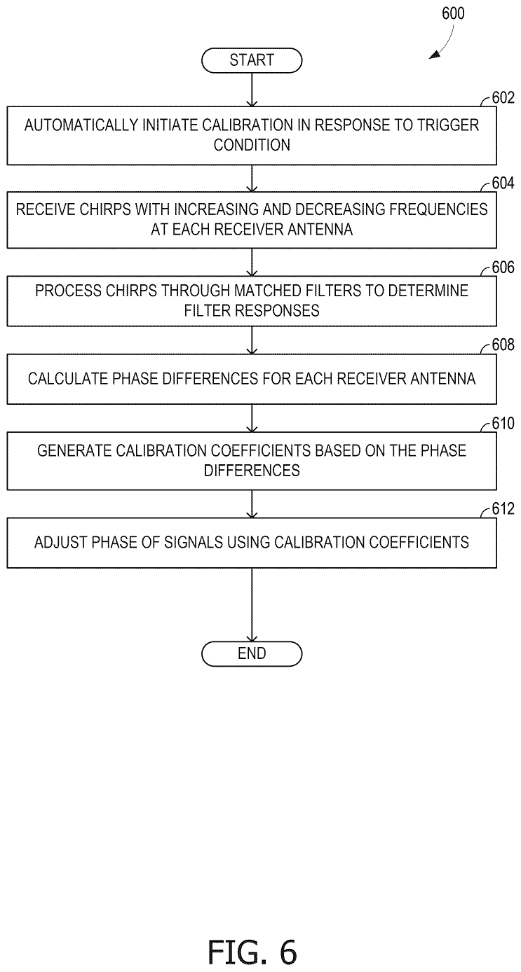

FIG. 6 is a flow chart illustrating an example process 600 of calibrating receiver antennas. Process 600 can be implemented according to the other systems and methods of the disclosure.

At operation 602, automatically initiate calibration in response to a trigger condition. At operation 604, receive chirps with increasing and decreasing frequencies at each receiver antenna. At operation 606, process chirps through matched filters to determine filter responses. At operation 608, calculate phase differences for each receiver antenna. At operation 610, generate calibration coefficients based on the phase differences. At operation 612, adjust phase of signals using the calibration coefficients.

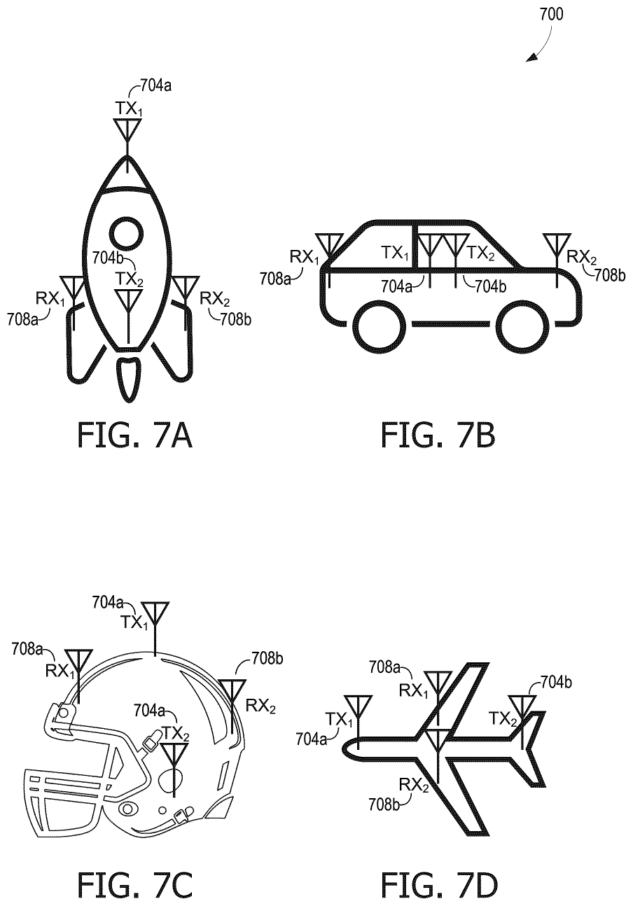

FIGS. 7A-D are illustrations of example implementations of antennas calibration systems 700. The example antenna calibration systems 700 use two or more transmitter antennas 704a-b and two or more receiver antennas 708a-b. The transmitter antennas 704a-b send chirps to the receiver antennas 708a-b to calibrate the phases of signals received by the receiver antennas 708a-b. The phases need to be calibrated because of electrical path variations caused by repeated shocks, vibrations, or temperature changes that occur in the various implementations. In each of the examples, the cartesian coordinates of the transmitter antennas 704a-b and the receiver antennas 708a-b are known. Calibration systems 700 can be implemented according to the other systems and methods of the disclosure.

FIG. 7A depicts antenna calibration system 700 implemented on a rocket, which might be manned or unmanned. The receiver antennas 708a and 708b are fixed to the fins of the rocket while transmitter antennas 704a and 704b are fixed to the fore and aft portions of the rocket. The fins experience significant vibrations and temperature changes during liftoff in the atmosphere, leading to electrical path changes. The receiver antennas 708a-b can be re-calibrated multiple times during operation to account for the electrical path changes.

FIG. 7B depicts antenna calibration system 700 implemented in an automotive vehicle, which might be manned or unmanned. The receiver antennas 708a and 708b are fixed to the front and rear portions of the vehicle while transmitter antennas 704a and 704b are fixed to internal portions of the vehicle. The receiver antenna 708a and 708b could be subject to shocks from vehicle collisions, leading to electrical path changes. The receiver antennas 708a-b can be re-calibrated multiple times during operation to account for the electrical path changes.

FIG. 7C depicts antenna calibration system 700 implemented within a football helmet. The receiver antennas 708a and 708b are embedded within the front and rear portions of the helmet while transmitter antennas 704a and 704b are embedded within the top and bottom portions of the helmet. The receiver antenna 708a and 708b may be subject to repeated shocks from player collisions during use, leading to electrical path changes. The receiver antennas 708a-b can be re-calibrated multiple times during operation to account for the electrical path changes.

FIG. 7D depicts antenna calibration system 700 implemented on an aerial vehicle, which might be manned or unmanned. The receiver antennas 708a and 708b are fixed to the wings of the vehicle while transmitter antennas 704a and 704b are fixed to the nose and tail of the vehicle. The wings experience significant vibrations and temperature changes during flight, leading to electrical path changes. The receiver antennas 708a-b can be re-calibrated multiple times during operation to account for the electrical path changes.

The chirps can be processed in parallel or sequentially. In at least one embodiment, the processing is performed sequentially. Sending the chirps at different times allows for simpler processing, which reduces the computational hardware required to process the chirps. In contrast, processing the chirps in parallel reduces overall processing time. The chirps can have any duration, wavelengths, and frequencies.

In an example implementation, the calibration process is controlled by instructions encoded in software, hardware, and/or firmware. The instructions manage the sequence and timing of the calibration operations. The software may be implemented on a computing device integrated with the antenna array system and/or as a separate control unit. Example instructions or process flow includes automatic calibration initiation, in-phase and quadrature data recording, matched filter processing, phase difference calculation, calibration coefficient generation, and signal phase adjustment. For automatic calibration initiation, the instructions may detect when a trigger condition is satisfied, such as when a vibration threshold is exceeded, when a shock threshold is detected, when a temperature change threshold is surpassed, when a fixed calibration schedule interval has elapsed, when geolocation coordinates match a predetermined location, or when the system initiates signal capture. The instructions may also configure the system by verifying the readiness of the transmitter antenna array and the receiver antenna array for calibration operations.

During calibration execution, the instructions may record in-phase and quadrature data from the receiver antennas for a duration corresponding to the length of the transmitted frequency-modulated signals. The instructions may pass the recorded data through parallel matched filters, with each filter corresponding to a respective frequency-modulated signal from a transmitter antenna. The instructions may then detect the peak of each matched filter response and measure the phase of the peak response from each transmitter antenna. For phase difference calculation, the instructions may compute a measured phase for each frequency-modulated signal and compute an expected phase based on the propagation length between a transmitter antenna and a receiver antenna. The instructions may then compute a calibrated phase for each transmitter antenna by comparing the measured phase to the expected phase, and may compute an electrical phase error across the transmitter antennas by calculating the mean of peak phases. The instructions may generate calibration coefficients based on the calculated phase differences and store the coefficients in memory. During signal adjustment, the instructions may multiply the in-phase and quadrature data of incoming signals by respective calibration coefficients to align the phase of signals across the receiver antenna array.

### Exemplary Operating Environment

The present disclosure is operable with a computing apparatus according to an embodiment as a functional block diagram 800 in FIG. 8. In an example, components of a computing apparatus 802 are implemented as a part of an electronic device according to one or more embodiments described in this specification. The computing apparatus 802 comprises one or more processors 804 which may be microprocessors, controllers, or any other suitable type of processors for processing computer executable instructions to control the operation of the electronic device. Alternatively, or in addition, the processor 804 is any technology capable of executing logic or instructions, such as a hard-coded machine. In some examples, platform software comprising an operating system 806 or any other suitable platform software is provided on the apparatus 802 to enable application software 808 to be executed on the device. In some examples, calibrating receiver antennas to account for electrical path variation by sending chirps from transmitter antennas as described herein is accomplished by software, hardware, and/or firmware.

In some examples, computer executable instructions are provided using any computer-readable media that is accessible by the computing apparatus 802. Computer-readable media include, for example, computer storage media such as a memory 810 and communications media. Computer storage media, such as a memory 810, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 810) is shown within the computing apparatus 802, it will be appreciated by a person skilled in the art, that, in some examples, the storage is distributed or located remotely and accessed via a network or other communication link (e.g., using a communication interface 812).

Further, in some examples, the computing apparatus 802 comprises an input/output controller 814 configured to output information to one or more output devices 816, for example a display or a speaker, which are separate from or integral to the electronic device. Additionally, or alternatively, the input/output controller 814 is configured to receive and process an input from one or more input devices 818, for example, a keyboard, a microphone, or a touchpad. In one example, the output device 816 also acts as the input device. An example of such a device is a touch sensitive display. The input/output controller 814 may also output data to devices other than the output device, e.g., a locally connected printing device. In some examples, a user provides input to the input device(s) 818 and/or receives output from the output device(s) 816.

The functionality described herein can be performed, at least in part, by one or more hardware logic components. According to an embodiment, the computing apparatus 802 is configured by the program code when executed by the processor 804 to execute the embodiments of the operations and functionality described. Alternatively, or in addition, the functionality described herein can be performed, at least in part, by one or more hardware logic components. For example, and without limitation, illustrative types of hardware logic components that can be used include FPGAs, Application-specific Integrated Circuits (ASICs), Application-Specific Standard Products (ASSPs), System-on-a-chip systems (SOCs), Complex Programmable Logic Devices (CPLDs), Graphics Processing Units (GPUS).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example antenna calibration system comprises: a receiver antenna array; a transmitter antenna array; a processor; and a memory comprising computer program code, the memory and the computer program code configured to cause the processor to: automatically initiate calibration in response to a trigger condition; receive frequency-modulated signals from the transmitter antenna array at each receiver antenna; process the frequency-modulated signals through matched filters to determine filter responses; calculate phase differences for each receiver antenna; generate calibration coefficients based on the phase differences; and adjust the phase of signals received using the calibration coefficients.

An example computerized method for calibrating a receiver antenna array using a transmitter antenna array comprises: automatically initiating calibration in response to a trigger condition; receiving frequency-modulated signals at each receiver antenna; processing the frequency-modulated signals through matched filters to determine filter responses; calculating phase differences for each receiver antenna; generating calibration coefficients based on the phase differences; and adjusting the phase of signals received using the calibration coefficients.

One or more computer storage media have computer-executable instructions that, upon execution by a processor, cause the processor to at least: automatically initiate calibration in response to a trigger condition, wherein calibration involves two or more receiver antennas; receive frequency-modulated signals at each receiver antenna, wherein the frequency-modulated signals are transmitted from two or more transmitter antennas; process the frequency-modulated signals through matched filters to determine filter responses; calculate phase differences for each receiver antenna; generate calibration coefficients based on the phase differences; and adjust the phase of signals received using the calibration coefficients.

Alternatively, or in addition to the other examples described herein, examples include any combination of the following:
record IQ data of the chirps;
measure a phase of peak response from each transmitter antennae;
compute a measured phase of chirps;
compute an expected phase of chirps;
compute a calibrated phase of each transmitter antennae;
compute an electrical phase error across the transmitter antennae, wherein the electrical phase error is the mean of peak phases across the transmitter antennae;
wherein one chirp has increasing frequencies and another chirp has decreasing frequencies;
wherein the trigger condition is a detected vibration threshold;
wherein the trigger condition is a detected shock threshold;
wherein the trigger condition is a detected temperature change threshold; and
wherein the trigger condition is a fixed calibration schedule.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. An antenna calibration system comprising:
a receiver antenna array;
a transmitter antenna array;
a processor; and
a memory comprising computer program code, the memory and the computer program code configured to cause the processor to:
automatically initiate calibration in response to a trigger condition;
receive frequency-modulated signals from the transmitter antenna array at each receiver antenna;
process the frequency-modulated signals through matched filters to determine filter responses;
calculate phase differences for each receiver antenna;
generate calibration coefficients based on the phase differences; and
adjust the phase of signals received using the calibration coefficients.

2. The antenna calibration system of claim 1, wherein the memory and the computer program code are further configured to cause the processor to:
record in-phase and quadrature (IQ) data of the frequency-modulated signals.

3. The antenna calibration system of claim 2, wherein calculating phase differences for each receiver antenna further causes the processor to:
measure a phase of peak response from each transmitter antenna;
compute a measured phase of frequency-modulated signals;
compute an expected phase of frequency-modulated signals; and
compute a calibrated phase of each transmitter antenna.

4. The antenna calibration system of claim 1, wherein generating calibration coefficients based on the phase differences further causes the processor to:
compute an electrical phase error across the transmitter antennas, wherein the electrical phase error is the mean of peak phases across the transmitter antennas.

5. The antenna calibration system of claim 1, wherein one frequency-modulated signal has increasing frequencies and another frequency-modulated signal has decreasing frequencies.

6. The antenna calibration system of claim 1, wherein the trigger condition is a detected vibration threshold.

7. The antenna calibration system of claim 1, wherein the trigger condition is a fixed calibration schedule.

8. A computerized method for calibrating a receiver antenna array using a transmitter antenna array comprising:
automatically initiating calibration in response to a trigger condition;
receiving frequency-modulated signals at each receiver antenna;
processing the frequency-modulated signals through matched filters to determine filter responses;
calculating phase differences for each receiver antenna;
generating calibration coefficients based on the phase differences; and
adjusting the phase of signals received using the calibration coefficients.

9. The computerized method of claim 8, further comprising:
recording in-phase and quadrature (IQ) data of the frequency-modulated signals.

10. The computerized method of claim 8, further comprising:
measuring a phase of peak response from each transmitter antenna;
computing a measured phase of frequency-modulated signals;
computing an expected phase of frequency-modulated signals; and
computing calibrated phase of each transmitter antenna.

11. The computerized method of claim 8, further comprising:
computing an electrical phase error across the transmitter antennas, wherein the electrical phase error is the mean of peak phases across the transmitter antennas.

12. The computerized method of claim 8, wherein one frequency-modulated signal has increasing frequencies and another frequency-modulated signal has decreasing frequencies.

13. The computerized method of claim 8, wherein the trigger condition is a detected vibration threshold.

14. The computerized method of claim 8, wherein the trigger condition is a fixed calibration schedule.

15. A non-transitory computer storage medium has computer-executable instructions that, upon execution by a processor, cause the processor to at least:
automatically initiate calibration in response to a trigger condition, wherein calibration involves two or more receiver antennas;
receive frequency-modulated signals at each receiver antenna, wherein the frequency-modulated signals are transmitted from two or more transmitter antennas;
process the frequency-modulated signals through matched filters to determine filter responses;
calculate phase differences for each receiver antenna;
generate calibration coefficients based on the phase differences; and
adjust the phase of signals received using the calibration coefficients.

16. The non-transitory computer storage medium of claim 15, wherein the instructions further cause the processor to at least:
record in-phase and quadrature (IQ) data of the frequency-modulated signals.

17. The non-transitory computer storage medium of claim 15, wherein the instructions further cause the processor to at least:
measure a phase of peak response from each transmitter antenna;
compute a measured phase of frequency-modulated signals;
compute an expected phase of frequency-modulated signals; and
compute a calibrated phase of each transmitter antenna.

18. The non-transitory computer storage medium of claim 15, wherein the instructions further cause the processor to at least:
compute an electrical phase error across the transmitter antennas, wherein the electrical phase error is the mean of peak phases across the transmitter antennas.

19. The non-transitory computer storage medium of claim 15, wherein one chirp has increasing frequencies and another chirp has decreasing frequencies.

20. The non-transitory computer storage medium of claim 15, wherein the trigger condition is a detected vibration threshold.
